(19) United States
(12) Patent Application Publication
(10) Pub. No.: US 2022/0358745 A1
(43) Pub. Date: Nov. 10, 2022

(54) STORE MONITORING SYSTEM, STORE MONITORING APPARATUS, STORE MONITORING METHOD AND RECORDING MEDIUM

(71) Applicant: NEC CORPORATION, Minato-ku, Tokyo (JP)

(72) Inventors: Jun UCHIMURA, Tokyo (JP); Yuji TAHARA, Tokyo (JP); Rina TOMITA, Tokyo (JP); Yasuyo KAZO, Tokyo (JP)

(73) Assignee: NEC Corporation, Minato-ku, Tokyo (JP)

(21) Appl. No.: 17/770,356

(22) PCT Filed: Oct. 28, 2020
(86) PCT No.: PCT/JP2020/040412

§ 371 Date: Apr. 20, 2022

(30) Foreign Application Priority Data
Oct. 31, 2019 (JP) 2019-198268

(51) Int. Cl. G06V 10/26; G06T 5/20; G06T 5/00; H04N 5/232

(52) U.S. Cl. CPC G06V 10/273; G06T 5/20; G06T 5/006; H04N 5/23218; H04N 5/23232; G06T 2207/30232

(57) ABSTRACT

A store monitoring system includes: an imaging apparatus; and a store monitoring apparatus that monitors a display shelf in a store by using a captured image captured by the imaging apparatus, the store monitoring apparatus including: an acquisition unit that sequentially obtains the captured image from the imaging apparatus; and an image generation unit that extracts from the captured image a shelf image in which the display shelf appears, by eliminating from the captured image a non-shelf image in which the display shelf does not appear, and that generates a front shelf image obtained when the display shelf is imaged from a front, by correcting a distortion of the shelf image.

### TECHNICAL FIELD

The present invention relates to a store monitoring system, a store monitoring apparatus, a store monitoring method, and a recording medium that monitor a display shelf in a store.

### BACKGROUND ART

A store monitoring system for monitoring a display shelf in a store, such as a supermarket and a convenience store, is known (e.g., see Patent Literatures 1 to 3). In addition, although it is not a literature that discloses a store monitoring system for monitoring a display shelf, Patent Literature 4 is cited as a prior art document related to the present invention.

### CITATION LIST

### Patent Literature

Patent Literature 1: JP2019-008622A
Patent Literature 2: JP2018-139062A
Patent Literature 3: JP2000-270297A
Patent Literature 4: JP2018-201146A

### SUMMARY

### Technical Problem

The store monitoring system typically includes an imaging apparatus installed in a store and a store monitoring apparatus that monitors a display shelf by using an image captured by the imaging apparatus. In this situation, the store monitoring apparatus preferably generates an image suitable for monitoring the display shelf from the captured image and monitors the display shelf by using the generated image. The store monitoring system described in the Patent Literatures 1 to 4 described above has room for improvement in that it generates an image suitable for monitoring the store from the captured image.

It is therefore an example object of the present invention to provide a store monitoring system, a store monitoring apparatus, a store monitoring method, and a recording medium that are configured to solve the technical problems described above. By way of example, it is an example object of the present invention to provide a store monitoring system, a store monitoring method, and a recording medium that are configured to appropriately generate an image suitable for monitoring a store from a captured image.

### Solution to Problem

An exemplary store monitoring system for solving the problem includes: an imaging apparatus; and a store monitoring apparatus that monitors a display shelf in a store by using a captured image captured by the imaging apparatus, the store monitoring apparatus including: an acquisition unit that sequentially obtains the captured image from the imaging apparatus; and an image generation unit that extracts from the captured image a shelf image in which the display shelf appears, by eliminating from the captured image a non-shelf image in which the display shelf does not appear, and that generates a front shelf image obtained when the display shelf is imaged from a front, by coffecting a distortion of the shelf image.

An exemplary store monitoring apparatus for solving the problem is a store monitoring apparatus that monitors a display shelf in a store, the store monitoring apparatus including: an acquisition unit that sequentially obtains a captured image captured by an imaging apparatus; and an image generation unit that extracts from the captured image a shelf image in which the display shelf appears, by eliminating from the captured image a non-shelf image in which the display shelf does not appear, and that generates a front shelf image obtained when the display shelf is imaged from a front, by coffecting a distortion of the shelf image.

An exemplary store monitoring method for solving the problem is a store monitoring method that monitors a display shelf in a store, the store monitoring method including: sequentially obtaining a captured image captured by an imaging apparatus; and extracting from the captured image a shelf image in which the display shelf appears, by eliminating from the captured image a non-shelf image in which the display shelf does not appear, and generating a front shelf image obtained when the display shelf is imaged from a front, by correcting a distortion of the shelf image.

An exemplary recording medium for solving the problem is a recording medium on which a computer program that allows a computer to execute a store monitoring method that monitors a display shelf in a store is recorded, the store monitoring method including: sequentially obtaining a captured image captured by an imaging apparatus; and extracting from the captured image a shelf image in which the display shelf appears, by eliminating from the captured image a non-shelf image in which the display shelf does not appear, and generating a front shelf image obtained when the display shelf is imaged from a front, by correcting a distortion of the shelf image.

### Advantageous Effects of Invention

According to the store monitoring system, the store monitoring apparatus, the store monitoring method, and recording medium described above, it is possible to appropriately generate an image suitable for monitoring a store from a captured image.

### BRIEF DESCRIPTION OF DRAWINGS

FIG. 1 is a block diagram illustrating an overall configuration of a store monitoring system according to an example embodiment.

FIG. 2 is a sketch illustrating an example of a store 5 in which the store monitoring system according to the example embodiment is adopted.

FIG. 3 is a block diagram illustrating a configuration of a store monitoring server according to the example embodiment.

FIG. 4 is a block diagram illustrating a configuration of an imaging apparatus according to the example embodiment.

FIG. 5 is a flow chart illustrating a flow of an image generation operation.

FIG. 6 is a plan view illustrating a captured image captured by the imaging apparatus.

FIG. 7 is a plan view illustrating a front shelf image generated from the captured image illustrated in FIG. 6.

FIG. 8A is a plan view illustrating a captured image in which a plurality of reference points are arranged, and FIG. 8B is a plan view illustrating a front shelf image, which is generated from the captured image illustrated in FIG. 8A, with the plurality of reference points.

FIG. 9 is a plan view illustrating a display apparatus that displays the front shelf image and a teacher image together with the captured image.

FIG. 10 is a plan view illustrating a display shelf in which a plurality of marks are arranged.

FIG. 11 is a plan view illustrating a captured image obtained by imaging the display shelf on which the plurality of marks illustrated in FIG. 10 are arranged, and FIG. 11B is a plan view illustrating the display shelf on which the plurality of marks are arranged.

FIG. 12 is a plan view illustrating another example of the display shelf on which the plurality of marks are arranged.

FIG. 13 is a plan view illustrating a captured image captured by a camera including a circumferential fisheye lens and a panoramic image generated by planarizing the captured image.

FIG. 14 is a block diagram illustrating another example of the configuration of the store monitoring server according to the example embodiment.

### DESCRIPTION OF EXAMPLE EMBODIMENT

With reference to the drawings, a store monitoring system, a store monitoring apparatus, a store monitoring method, and a recording medium according to an example embodiment will be described below. The following describes a store monitoring system 4 to which the store monitoring system, the store monitoring method, and the recording medium according to the example embodiment is applied.

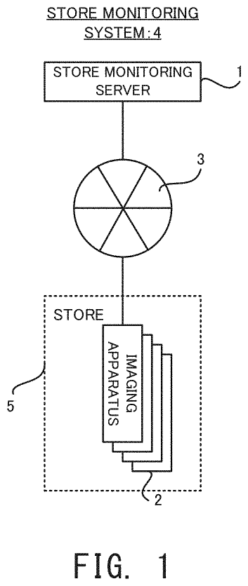

First, with reference to FIG. 1, a description will be given to an overall configuration of the store monitoring system 4 according to the example embodiment. FIG. 1 is a block diagram illustrating the overall configuration of the store monitoring system 4 according to the example embodiment.

As illustrated in FIG. 1, the store monitoring system 4 includes a store monitoring server 1 and a plurality of imaging apparatuses 2. The store monitoring system 4, however, may include a single imaging apparatus 2. The store monitoring server 1 and each of the imaging apparatuses 2 are allowed to communicate with each other through a network 3. The network 3 may include a wired network or may include a wireless network.

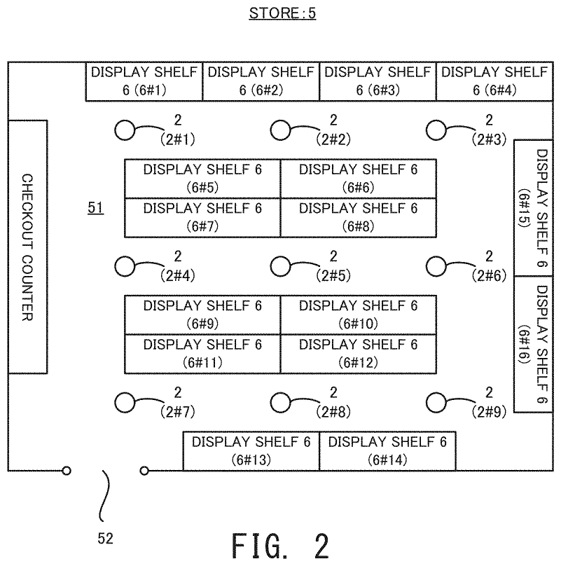

FIG. 2 illustrates an example of a store 5 in which such a store monitoring system 4 is adopted, as a sketch of the store 5. For example, as illustrated in FIG. 2, the store 5 includes a shopping space 51 in which a plurality of display shelves 6 are installed. FIG. 2 illustrates the shopping space 51 in which 16 display shelves 6 (specifically, a display shelf 6 #1 to a display shelf 6 #16) are installed. However, the number of display shelves 6 is not limited to 16. In the shopping space 51, 17 or more display shelves 6 may be installed, or 15 or less display shelves 6 may be installed, or a single display shelf 6 may be installed. A customer can enter the shopping space 51 from an outside of the store 5 through an entrance 52 of the store 5. As a result, the customer can purchase merchandise displayed on the display shelves 6 installed in the shopping space 51. Additionally, the customer may go out of the store 5 from the shop space 51 through the entrance 52. Incidentally, FIG. 2 illustrates an example in which the shopping space 51 is disposed inside the store 5. However, at least a part of the shopping space 51 may be disposed outside the store 5 (e.g., under the eaves of the store 5, etc.).

As illustrated in FIG. 2 (and also in FIG. 1), the imaging apparatuses 2 are disposed in positions in which the shopping space 51 (e.g., the inside and/or outside of the store 5) can be imaged. FIG. 2 illustrates an example in which nine imaging apparatuses 2 (specifically, an imaging apparatus 2 #1 to an imaging apparatus 2 #9) are disposed in the store 5. The imaging apparatus 2 generates a captured image 71 that indicates a condition of at least one display shelf 6, by imaging at least one display shelf 6 installed in the shopping space 51. The imaging apparatus 2 transmits (in other words, outputs) the generated captured image 71 to the store monitoring server 1 through the network 3.

The store monitoring server 1 receives (in other words, obtains) the captured image 71 transmitted from the imaging apparatus 2. The store monitoring server 1 monitors the display shelf 6 of the store 5 by using the obtained captured image 71. Specifically, the store monitoring server 1 performs an image generation operation for generating a front shelf image 72, which is obtained from the captured image 71 when the display shelf 6 that appears in the captured image 71 and that is to be monitored is imaged from the front. Furthermore, the store monitoring server 1 performs a monitoring operation for monitoring the display shelf 6 by using the generated front shelf image 72. Incidentally, the store monitoring server 1 may be disposed inside the store 5 or may be disposed outside the store 5.

Hereinafter, a configuration of each of apparatuses (i.e., the store monitoring server 1 and the imaging apparatuses 2) that constitute the store monitoring system 4 will be described in order.

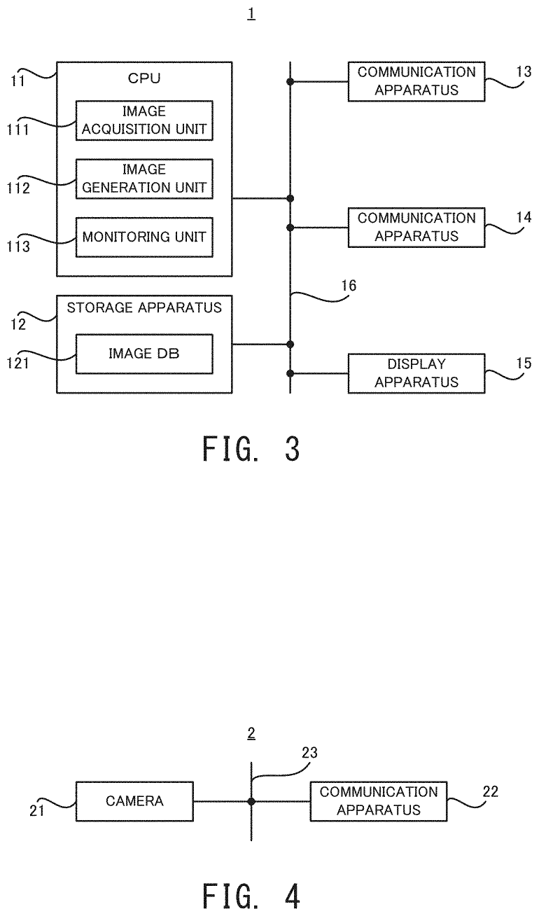

First, the configuration of the store monitoring server 1 according to the example embodiment will be described with reference to FIG. 3. FIG. 3 is a block diagram illustrating the configuration of the store monitoring server 1 according to the example embodiment.

As illustrated in FIG. 3, the store monitoring server 1 includes a CPU (Central Processing Unit) 11, a storage apparatus 12, a communication apparatus 13, an input apparatus 14, and a display apparatus 15. The CPU 11, the storage apparatus 12, the communication apparatus 13, the input apparatus 14, and the display apparatus 15 are connected through a data bus 16.

The CPU 11 reads a computer program. For example, the CPU 11 may read a computer program stored in the storage apparatus 12. For example, the CPU 11 may read a computer program stored in a computer readable recording medium, by using a not-illustrated recording medium read apparatus. The CPU 11 may obtain (i.e., may download or read) a computer program from a not-illustrated apparatus disposed outside the store monitoring server 1, via the communication apparatus 13. The CPU 11 executes the read computer program. Consequently, a logical functional block for performing an operation to be performed by the store monitoring server 1 (e.g., the image generation operation and the monitoring operation described above) is implemented in the CPU 11. In other words, the CPU 11 is configured to function as a controller for implementing a logical functional block for performing the operation to be performed by the store monitoring server 1.

FIG. 3 illustrates an example of the logical functional block, which is implemented in the CPU 11, for performing the operation to be performed by the store monitoring server 1. As illustrated in FIG. 3, an image acquisition unit 111, an image generation unit 112, and a monitoring unit 113 are implemented in the CPU 11. The image acquisition unit 111 sequentially obtains the captured image 71 from the imaging apparatus 2 via the communication apparatus 13 at each time when a camera 21 images the display shelf 6 (i.e., at each time when a new captured image 71 is generated). The image generation unit 112 generates the front shelf image 72 by performing the above-described image generation operation at each time when the camera 21 images the display shelf 6 (i.e., at each time when a new captured image 71 is generated). The monitoring unit 113 performs the above-described monitoring operation.

The storage apparatus 12 is configured to store desired data. For example, the storage apparatus 12 may temporarily store the computer program to be executed by the CPU 11. The storage apparatus 12 may temporarily store the data that is temporarily used by the CPU 11 when the CPU 11 executes the computer program. The storage apparatus 12 may store the data that is stored for a long term by the store monitoring server 1. Especially in the example embodiment, the storage apparatus 12 stores an image DB (DataBase) 121 that stores (i.e., records, memorizes, or accumulates) the front shelf image 72 generated by the image generation operation. That is, the storage apparatus 12 sequentially stores the front shelf image 72 generated from the captured image 71, in the image DB 121, at each time when the camera 21 images the display shelf 6 (i.e., at each time when a new captured image 71 is generated). The storage apparatus 12 may include at least one of a RAM (Random Access Memory), a ROM (Read Only Memory), a hard disk apparatus, a magnetic-optical disk apparatus, an SSD (Solid State Drive), and a disk array apparatus.

The communication apparatus 13 is configured to communicate with the plurality of imaging apparatuses 2 through the network 3. In the example embodiment, the communication apparatus 13 is configured to receive the captured image 71 captured by each of the imaging apparatuses 2, from each of the imaging apparatuses 2 through the network 3.

The input apparatus 14 is an apparatus that receives an input operation from a user of the store monitoring server 1 (e.g., a manager of the store 5). The input apparatus 14 may include, for example, a user-operable operating apparatus. The input apparatus 14 may include, for example, at least one of a keyboard, a mouse, and a touch panel, as an example of the operating apparatus.

The display apparatus 15 is an output apparatus (i.e. a display) that is configured to display a desired image.

Next, with reference to FIG. 4, a description will be given to the configuration of the imaging apparatus 2 according to the example embodiment. FIG. 4 is a block diagram illustrating the configuration of the imaging apparatus 2 according to the example embodiment.

As illustrated in FIG. 4, the imaging apparatus 2 includes a camera 21 and a communication apparatus 22. The camera 21 and the communication apparatus 22 may be connected through a data bus 23.

The camera 21 is an apparatus that generates the captured image 71 that indicates the condition of at least one display shelf 6, by imaging at least one display shelf 6. Specifically, the camera 21 is disposed in the store 5 so as to position (i.e., include) at least one display shelf 6 to be imaged by the camera 21 within an imaging range (in other words, an imaging view angle) of the camera 21. That is, the camera 21 is disposed in the store 5 so as to image one display shelf 6 to be imaged by the camera 21. In this example embodiment, the imaging range of the camera 21 is preferably fixed in principle. In other words, at least one display shelf 6 to be imaged by the camera 21 preferably remains unchanged in principle. The camera 21 preferably continues to image the same display shelf 6.

The camera 21 continues to image the display shelf 6 at a predetermined imaging rate. For example, if the predetermined imaging rate is set to 1 fps (Frame Per Sec), the camera 21 repeats an operation of imaging the display shelf 6 once per second such that one captured image 71 is generated per second.

The camera 21 may be a camera including a wide-angle lens. The camera 21 may be a fisheye camera including a circumferential fisheye lens. The camera 21 may be a fisheye camera including a diagonal fisheye lens. The camera 21 may be a camera including other types of lenses.

The communication apparatus 22 is configured to communicate with the store monitoring server 1 through the network 3. In the example embodiment, the communication apparatus 22 is configured to transmit the captured image 71 captured by the camera 21 to the store monitoring server 1 through the network 3.

In the description described above, each of the plurality of imaging apparatuses 2 includes the communication apparatus 22. However, at least two of the imaging apparatuses 2 may transmit the captured image 71 to the store monitoring server 1 by using a shared communication apparatus 22. In this case, at least two cameras 21 and the shared communication apparatus 22, which are included by each of at least two imaging apparatus 2 that uses the shared communication apparatus 22, may be connected through a not-illustrated data bus.

Next, the operation of the store monitoring system 4 will be described. As described above, the store monitoring system 4 performs the monitoring operation and the image generation operation. For this reason, the monitoring operation and the image generation operation will be described in order below. In the example embodiment, the store monitoring server 1 mainly performs the above-described operations together with the plurality of imaging apparatuses 2. Therefore, in the example embodiment, the operation performed by the store monitoring system 4 may be performed by the store monitoring server 1.

First, the monitoring operation of monitoring the display shelf 6 based on the front shelf image 72 generated by the image generation operation will be described.

The monitoring unit 113 may perform, as a part of the monitoring operation, an operation of monitoring whether or not an abnormality occurs in the display shelf 6 that appears in the front shelf image 72, based on the front shelf image 72. The abnormality that occurs in the display shelf 6 may include such an abnormality that the number of merchandise articles displayed on the display shelf 6 is below a lower limit. The abnormality that occurs in the display shelf 6 may include such an abnormality that the merchandise displayed on the display shelf 6 is lacking. The abnormality that occurs in the display shelf 6 may include such an abnormality that a size of an empty space in which the merchandise is not displayed on the display shelf 6 is greater than or equal to a predetermined size. The abnormality that occurs in the display shelf 6 may include such an abnormality that the display shelf 6 displays merchandise that is different from the merchandise to be displayed on the display shelf 6.

The monitoring unit 113 may perform, as a part of the monitoring operation, an operation of notifying the user of the store monitoring system 4 (e.g., as described above, the manager of the store 5) that an abnormality has occurred in the display shelf 6. For example, the monitoring unit 113 may control the display apparatus 15 such that an alert image indicating that an abnormality has occurred in the display shelf 6 is displayed on the display apparatus 15. For example, the monitoring unit 113 may control a user terminal such that an alert image indicating that an abnormality has occurred in the display shelf 6 is displayed on the user terminal (e.g., a portable terminal such as a smartphone) possessed by the user. As a result, the user can recognize that an abnormality has occurred in the display shelf 6 at an early stage. The user can take measures to eliminate the abnormality that has occurred in the display shelf 6.

As described above, the storage apparatus 12 sequentially stores the front shelf image 72 generated from the captured image 71, in the image DB 121, at each time when the camera 21 images the display shelf 6 (i.e., at each time when a new captured image 71 is generated). Here, if the condition of the display shelf 6 that appears in the front shelves image 72 is not changed or is not changed much, a plurality of front shelf images 72 each of which shows substantially the same condition of the display shelf 6 (i.e., substantially the same front shelf images 72) are stored in the image DB 121. However, if the condition of the shelves 6 that appears in the front shelves image 72 is not changed or is not changed much, it can be said that there is a relatively low necessity for storing all the front shelf images 72 each of which shows substantially the same condition of the display shelf 6. On the other hand, when the condition of the display shelf 6 that appears in the front shelf image 72 is relatively greatly changed, the store monitoring system 4 is allowed to appropriately monitor how the condition of the display shelf 6 is changed if a plurality of front shelf images 72 generated from a plurality of captured images 71 obtained at relatively short time intervals are stored. Therefore, the storage apparatus 12 may change the number of front shelf images 72 stored per unit time by the storage apparatus 12 in the image DB 121, based on an amount of change per unit time in the condition of the display shelf 6 that appears in the front shelf image 72. Typically, the storage apparatus 12 may change the number of front shelf images 72 stored per unit time by the storage apparatus 12 in the image DB such that the number of front shelf images 72 stored per unit time by the storage apparatus 12 in the image DB is reduced with reducing amount of change per unit time in the condition of the display shelf 6 that appears in the front shelf image 72. The storage apparatus 12 may change the number of front shelf images 72 stored per unit time by the storage apparatus 12 in the image DB such that the number of front shelf images 72 stored per unit time by the storage apparatus 12 in the image DB is increased with increasing amount of change per unit time in the condition of the display shelf 6 that appears in the front shelf image 72. For example, the storage apparatus 12 may store a first number of front shelf images 72 per unit time when the amount of change per unit time in the condition of the display shelf 6 is a first amount, and may store a second number of front shelf images 72 per unit time when the amount of change per unit time in the condition of the display shelf 6 is a second amount, wherein the second number is greater than the first number, and the second amount is greater than the first amount. This consequently prevents compression of a storage capacity of the storage apparatus 12 caused by the storage of substantially the same front shelf images 72, and allows appropriate monitoring of the display shelf 6 whose condition varies significantly.

The amount of change per unit time in the condition of the display shelf 6 that appears in the front shelf image 72 may be calculated by the monitoring unit 113. In this case, the monitoring unit 113 may control the storage apparatus 12 so as to change the number of the front shelf images 72 stored per unit time by the storage apparatus 12 in the image DB, based on the amount of change per unit time in the condition of the display shelf 6 that appears in the front shelf image 72.

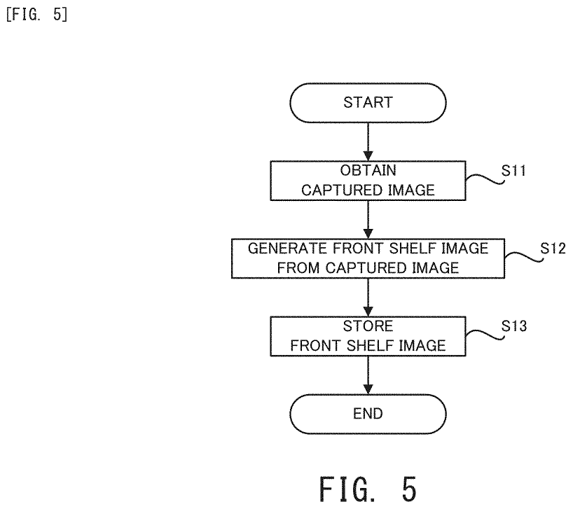

Next, with reference to FIG. 5, the image generation operation of generating the front shelf image 72 used in the monitoring operation will be described. FIG. 5 is a flow chart illustrating a flow of the image generation operation.

As illustrated in FIG. 5, the image acquisition unit 111 obtains the captured image 71 from the imaging apparatus 2 via the communication apparatus 13 (step S11). Here, as described above, the camera 21 of the imaging apparatus 2 continues to image the display shelf 6 at the predetermined imaging rate. For this reason, the image acquisition unit 111 sequentially obtains the captured image 71 from the imaging apparatus 2 at each time when the cameras 21 images the display shelf 6 (i.e., at each time when a new captured image 71 is generated). That is, at each time when the camera 21 images the display shelf 6 (i.e., at each time when a new captured image 71 is generated), the store monitoring server 1 sequentially starts the image generation operation illustrated in FIG. 5.

The store monitoring server 1 may perform the image generation operation for a part of the plurality of captured images 71 received from the imaging apparatus 2, but may not perform the image generation operation for another part of the captured images 71 received from the imaging apparatus 2. In this case, as compared with a case where the image generation operation is performed for all the captured images 71 received from the imaging apparatus 2, a processing load required for the image generation operation is reduced.

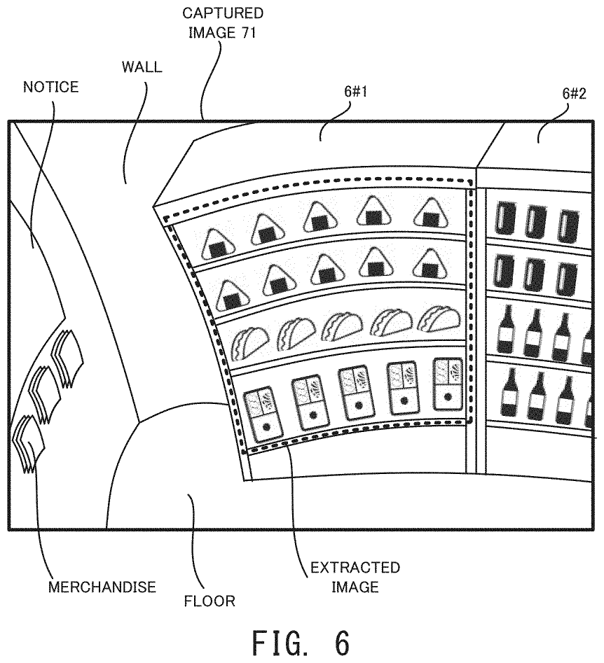

Then, the image generation unit 112 generates the front shelf image 72 from the captured image 71 obtained in the step S11 (step S12). Here, the reason for generating the front shelf image 72 from the captured image 71 will be described with reference to FIG. 6. FIG. 6 is a plan view illustrating the captured image 71.

The camera 21 of the imaging apparatus 2 installed in the store 5 usually has a difficulty in imaging the display shelf 6 to be imaged by the camera 21, from the front. For this reason, usually, the camera 21 is often disposed on the ceiling of the store 5, and images the display shelf 6 from above or diagonally above the display shelf 6. In this case, since the camera 21 does not image the display shelf 6 from the front, as illustrated in FIG. 6, there is a possibility that the display shelf 6 appears distorted in the captured image 71.

Additionally, the imaging range of the camera 21 may include an object that differs from the display shelf 6 to be imaged by the camera 21. Consequently, the object that differs from the display shelf 6 to be imaged by the camera 21 may appear in the captured image 71 captured by the camera 21. For example, FIG. 6 illustrates the captured image 71 captured by the camera 21 that should image the display shelf 6 #1 (e.g., the camera 21 of the imaging apparatus 2 #1 in FIG. 2 (hereinafter referred to as a “camera #21”)). As illustrated in FIG. 6, the captured image 71 shows not only the display shelf 6 #1, but also the display shelf 6 #2 that may not be imaged by the camera 21 #1. As illustrated in FIG. 6, the captured image 71 shows not only the display shelf 6 #1, but also an object other than the display shelf 6 (e.g., at least one of the floor of the store 5, the wall of the store 5, the merchandise sold in the store 5 and a notice of the store 5). It can be said that the object that differs from the display shelf 6 to be imaged by the camera 21 is an object that is not required to monitor the display shelf 6.

Thus, the captured image 71 is not necessarily a suitable image for monitoring the display shelf 6. Therefore, in the example embodiment, the image generation unit 112 generates, from the captured image 71, the front shelf image 72 that is more suitable for monitoring the display shelf 6 than the captured image 71. Consequently, the display shelf 6 can be monitored by the monitoring operation described later, more appropriately than when the front shelf image 72 is not generated.

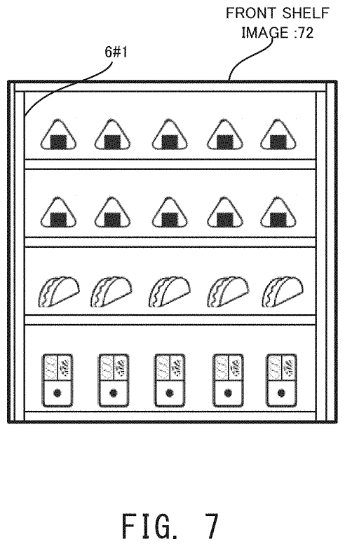

FIG. 7 illustrates the front shelf image 72 generated from the captured image 71 illustrated in FIG. 6. As illustrated in FIG. 7, the display shelf 6 that appears in the front shelf image 72 is less distorted than the display shelf 6 that appears in the captured image 71. Alternatively, the display shelf 6 that appears in the front shelf image 72 is undistorted. Furthermore, the front shelf image 72 does not show the object that is not required to monitor the display shelf 6, which appears in the captured image 71. The store monitoring server 1 uses the front shelf image 72 to perform the monitoring operation.

In order to generate the front shelf image 72 from the captured image 71, the image generation unit 112 extracts, from the captured image 71, an image portion (i.e., a shelf image) that shows the display shelf 6 to be included in the front shelf image 72. In other words, the image generation unit 112 excludes, from the captured image 71, a remaining image portion other than the image portion that shows the display shelf 6 to be included in the front shelf image 72. The image generation unit 112 excludes, from the captured image 71, an image portion (i.e., a non-shelf image portion) that does not show the display shelf 6 to be included in the front shelf image 72. In the example embodiment illustrated in FIG. 6, the image generation unit 112 may extract an image portion in a thick dotted line surrounding the display shelf 6 #1, as an extracted image. In other words, the image generation unit 112 may eliminate an image portion that is outside the thick dotted line surrounding the display shelf 6 #1.

In order to generate the front shelf image 72 from the captured image 71, the image generation unit 112 corrects the distortion of the extracted image corresponding to the image of the display shelf 6 extracted. Specifically, the image generation unit 112 deforms the extracted image such that the distortion of the extracted image is reduced or eliminated. The image generation unit 112 deforms the extracted image such that the distortion of the display shelf 6 that appears in the extracted image is reduced or eliminated. Consequently, the extracted image with the distortion corrected is used as the front shelf image 72.

Alternatively, the image generation unit 112, after correcting the distortion of the captured image 71, may extract the image portion that shows the display shelf 6 to be included in the front shelf image 72, from the captured image 71 with the distortion corrected. That is, the image generation unit 112, after correcting the distortion of the captured image 71, may exclude the image portion that does not show the display shelf 6 to be included in the front shelf image 72, from the captured image 71 with the distortion corrected. Alternatively, the image generation unit 112 may perform a process of correcting the distortion of the captured image 71 and a process of extracting the image portion that shows the display shelf 6 to be included in the front shelf image 72 from the captured image 71, simultaneously or in parallel. In other words, the image generation unit 112 may perform a process of correcting the distortion of the captured image 71 and a process of excluding the image portion that does not show the display shelf 6 to be included in the front shelf image 72 from the captured image 71, simultaneously or in parallel. In either case, the front shelf image 72 is generated from the captured image 71.

Again, in FIG. 5, the front shelf image 72 generated in the step S12 is stored in the image DB 121 stored in the storage apparatus 12 (step S13). Here, as described above, at each time when the camera 21 images the display shelf 6 (i.e., at each time when a new captured image 71 is generated), the store monitoring server 1 sequentially starts the image generation operation illustrated in FIG. 5. Therefore, the image generation unit 112 sequentially generates the front shelf image 72 at each time when the camera 21 images the display shelf 6 (i.e., at each time when a new captured image 71 is generated). Therefore, the storage apparatus 12 also sequentially stores the front shelf image 72 in the image DB 121 at each time when the image generation unit 112 generates the front shelf image 72. The front shelf image 72 stored in the storage apparatus 12 is used, for example, to monitor the display shelf 6 in the monitoring operation described later.

Next, a specific method for generating the front shelf image 72 from the captured image 71 will be described. In the example embodiment, the image generation unit 112 uses at least one of a first image generation method, a second image generation method and a third image generation method to generate the front shelf image 72 from the captured image 71. The first image generation method, the second image generation method, and the third image generation method differ from each other in that they have different methods of setting processing details (i.e., details of a process for generating the front shelf image 72 from the shooting image 71). Therefore, in the following, the first to third image generation methods will be described in order.

An operation for setting the processing details of the image generation method (e.g., an operation for setting the processing details of the image generation method based on the user's setting operation described later, an operation for setting the processing details of the image generation method based on a mark 91 described later, or an operation for setting the processing details of the image generation method based on a teacher image 73) may be performed before the start of operation of the store monitoring system 4. The operation for setting the processing details of the image generation method may be performed after the start of operation of the store monitoring system 4. Once the processing details of the image generating method is set, the image generation unit 112 may generate the front shelf image 72 in accordance with the set processing details. In other words, it is sufficient to perform the operation for setting the image generation method at least once. Even when the operation for setting the image generation method has already been performed, however, the operation for setting the image generation method may be performed again. Consequently, the processing details of the image generation methods is set (in other words, changed, adjusted or updated) so as to generate a more appropriate front shelf image 72.

The first image generation method is an image generation method whose processing details are set based on an instruction from the user of the store monitoring system 4 (e.g., the manager of the store 5, as described above). Specifically, the user inputs the setting operation for setting the processing details of the first image generation method, by using the input apparatus 14. The image generation unit 112 sets the processing details of the first image generation method based on the content of the setting operation performed by the user's using the input processing 14. In this case, it can be said that the image generation unit 112 generates the front shelf image 72 from the captured image 71 based on the content of the setting operation performed by the user using the input apparatus 14.

When using the first image generation method, the image generation unit 112 may firstly control the display apparatus 15, so as to display the captured image 71. Consequently, the captured image 71 is displayed on the display apparatus 15. In this case, the user can perform the setting operation for setting the processing details of the first image generation method, while referring to the captured image 71 displayed on the display apparatus 15. Therefore, the user can set the processing details of the first image generation method, more easily than when the captured image 71 is not displayed.

When the captured image 71 is displayed on the display apparatus 15, the setting operation for setting the processing details of the first image generation method may include an operation of disposing a plurality of reference points 81 on the captured image 71 displayed on the display apparatus 15. When the reference points 81 are disposed on the captured image 71, the image generation unit 112 may control the display apparatus 15 so as to display the disposed reference points 81 together with the captured image 71.

In this case, the user disposes the plurality of reference points 81 on the captured image 71 such that the reference points 81 disposed on the captured image 71 are arranged in a predetermined arrangement pattern on the front shelf image 72 generated from the captured image 71. That is, when the front shelf image 72 is generated from the captured image 71 in a situation where the reference points 81 are respectively disposed in a plurality of pixels in the captured image 71, the user disposes the reference points 81 on the captured image 71 such that the corresponding pixels in the front shelf image 72 (i.e., the pixels in which the reference points 81 are respectively disposed) are arranged in the predetermined arrangement pattern. In other words, the user disposes the reference points 81 arranged in the predetermined arrangement pattern on the front shelf image 72 with the distortion corrected, at corresponding positions on the captured image 71 in which the distortion is not yet corrected (i.e., a plurality of pixels corresponding to the pixels in which the reference points 81 are respectively arranged in the front shelf image 72).

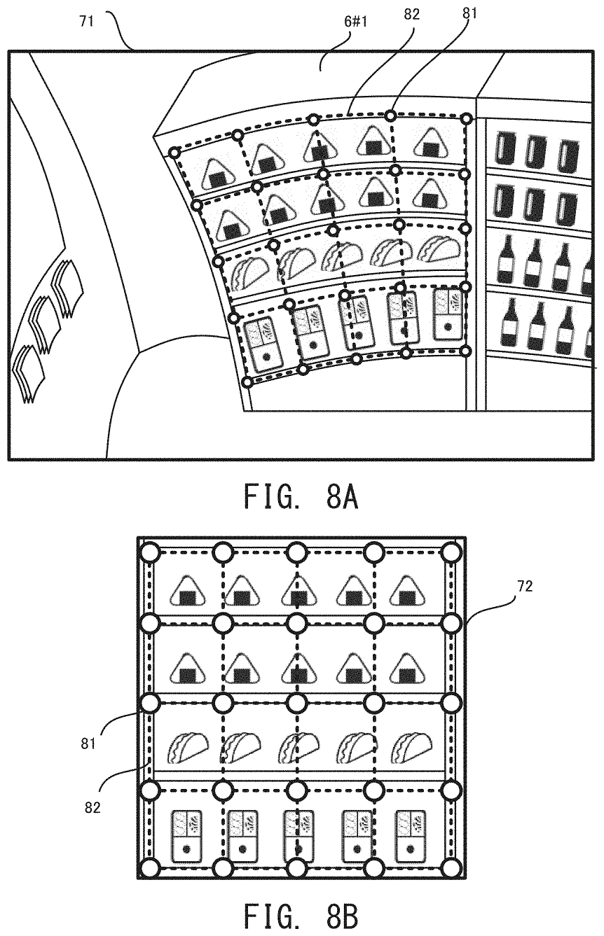

For example, FIG. 8A illustrates the captured image 71 in which the plurality of reference points 81 are arranged, and FIG. 8B illustrates, with the reference points 81, the front shelf image 72 generated from the captured image 71 illustrated in FIG. 8A. In the example illustrated in FIG. 8A and FIG. 8B, the user disposes the reference points 81 on the captured image 71 such that the reference points 81 disposed on the captured image 71 are arranged in a matrix-like (i.e., grid-like) arrangement pattern of 5 rows×5 columns on the front shelf image 72. That is, in the example illustrated in FIG. 8A and FIG. 8B, when the front shelf image 72 is generated from the captured image 71 in a situation where the reference points 81 are respectively arranged in the pixels in a plurality of captured images 71, the user disposes the reference points 81 on the captured image 71 such that the corresponding pixels in the front shelf image 72 are arranged in the matrix-like arrangement pattern of 5 rows×5 columns. In other words, the user disposes the reference points 81 arranged in the matrix-like arrangement pattern of 5 rows×5 columns on the front shelf image 72, at corresponding positions on the captured image 71 in which the distortion is not yet corrected.

When the reference points 81 are disposed such that the reference points 81 are arranged in the matrix-like arrangement pattern on the front shelf image 72 as illustrated in FIG. 8A and FIG. 8B, the image generation unit 112 may control the display apparatus 15 so as to display a plurality of reference lines 82 that connect the disposed reference points 81 in a grid shape, together with the captured image 71. As illustrated in FIG. 8A, however, due to the distortion of the captured image 71, the reference lines 82 displayed with the captured image 71 may not necessarily form grid lines intersecting regularly or periodically. On the other hand, as illustrated in FIG. 8B, the reference lines 82 forms grid lines intersecting regularly or periodically, in the front shelf image 72. In this case, the user may dispose the reference points 81 on the captured image 71 such that the reference lines 82 form grid lines intersecting regularly or periodically in the front shelf image 72 (i.e., such that the reference lines 82 are arranged in the predetermined arrangement pattern).

When such a plurality of reference points 81 are set, the image generation unit 112 sets the processing details of the first image generation method, for example, based on the disposed positions of the reference points 81 in the captured image 71 and the original arrangement pattern of the reference points 81 (the matrix-like arrangement pattern in the example illustrated in FIG. 8A and FIG. 8B). For example, the image generation unit 112 may set details of a process for deforming the captured image 71 such that the reference points 81 disposed on the captured image 71 are arranged in the predetermined arrangement pattern, as the processing details of the first image generation method. Considering that the reference points 81 are connected by the reference line 82, for example, the image generation unit 112 may set details of a process for deforming the captured image 71 such that the reference lines 82 disposed on the captured image 71 are arranged in the predetermined arrangement pattern, as the processing details of the first image generation method.

The image generation unit 112 sets the processing details of the first image generation method for each of the display shelves 6. This is because, when different display shelves 6 are respectively imaged by different cameras 21, the distortion of the display shelf 6 that appears in the captured image 71 varies depending on a positional relation between the display shelf 6 and the corresponding camera 21. Furthermore, it is because, even when different display shelves 6 are imaged by a single camera 21, the distortion of the display shelf 6 varies depending on a position where the display shelf 6 appears in the captured image 71 as the display shelves 6 appear at respective different positions in the captured image 71. For example, in the example illustrated in FIG. 2, the image generation unit 112 separately sets processing description of the first image generation method for generating the front shelf image 72 corresponding to the display shelf 6 #1, processing details of the first image generation method for generating the front shelf image 72 corresponding to the display shelf 6 #2, processing details of the first image generation method for generating the front shelf image 72 corresponding to the display shelf 6 #3, . . . , and processing details of the first image generation method for generating the front shelf image 72 corresponding to the display shelf 6 #15, and processing details of the first image generation method for generating the front shelf image 72 corresponding to the display shelf 6 #16.

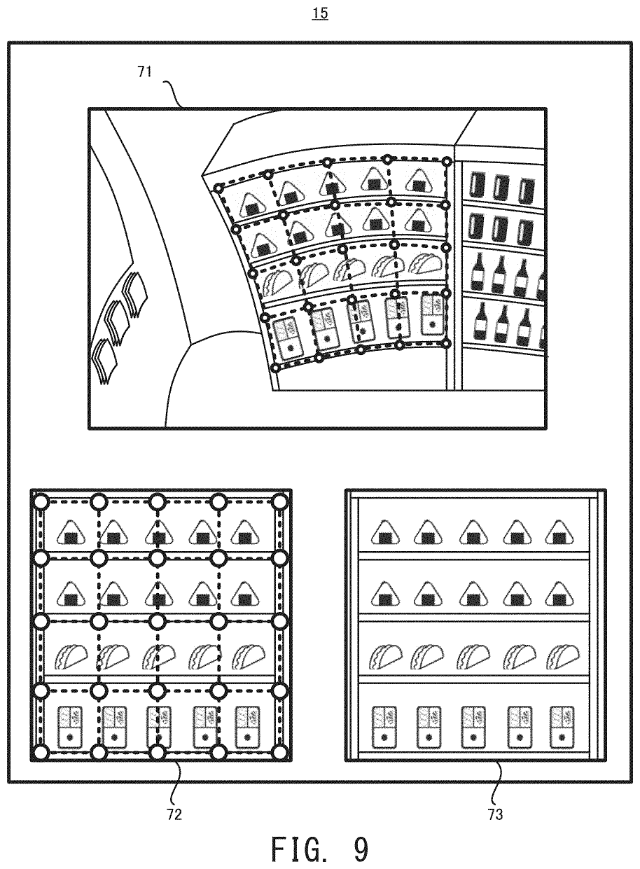

When using the first image generation method, as illustrated in FIG. 9, the image generation unit 112 may control the display apparatus 15 so as to display the front shelf image 72 generated from the captured image 71 displayed on the display apparatus 15, together with the captured image 71. In this case, the image generation unit 112 may regenerate the front shelf image 72 based on the latest set processing details at each time of setting the processing details of the first image generating method. In addition, the display apparatus 15 may display the latest front shelf image 72 regenerated, at each time when the image generation unit 112 regenerates the front shelf image 72. In this case, the user can perform the setting operation for setting the processing details of the first image generation method while referring to the front shelf image 72 generated by using the first image generation method whose processing details are set by the user's current setting operation. Therefore, the user can appropriately perform the setting operation for setting the processing details of the first image generation method such that the front shelf image 72 becomes an appropriate image.

When using the first image generation method, as illustrated in FIG. 9, the image generation unit 112 may control the display apparatus 15 so as to display the teacher image 73 alongside the front shelf image 72, wherein the teacher image 73 is obtained by actually imaging from the front side the display shelf 6 that appears in the captured image 71 displayed on the display apparatus 15. The teacher image 73 is typically an image obtained by actually imaging the display shelf 6 from the front, by using a camera that differs from the camera 21 of the imaging apparatus 2. The teacher image 73, however, may typically be an image obtained by actually imaging the display shelf 6 from the front, by using the camera 21 of the imaging apparatus 2. In this instance, the user can perform the setting operation for setting the processing details of the first image generation method while contrasting the front shelf image 72 and the teacher image 73. Therefore, the user can appropriately perform the setting operation for setting the processing details of the first image generation method such that the front shelf image 72 approaches or matches the teacher image 73.

Incidentally, the teacher image 73 may be an image obtained by actually imaging from the front the display shelf 6 having the same specifications as those of the display shelf 6 that appears in the captured image 71 displayed on the display apparatus 15. For example, the teacher image 73 may be an image obtained by actually imaging from the front the display shelf 6 of the same size as that of the display shelf 6 that appears in the captured image 71 displayed on the display apparatus 15. The teacher image 73 may be an image obtained by actually imaging from the front the display shelf 6 having the same shape as that of the display shelf 6 that appears in the captured image 71 displayed on the display apparatus 15. In such cases, even when it is difficult to actually image the display shelf 6 from the front, the teacher image 73 is available. Even in such cases, the user can appropriately perform the setting operations for setting the processing details of the first image generation method such that the front shelf image 72 approaches or matches the teacher image 73.

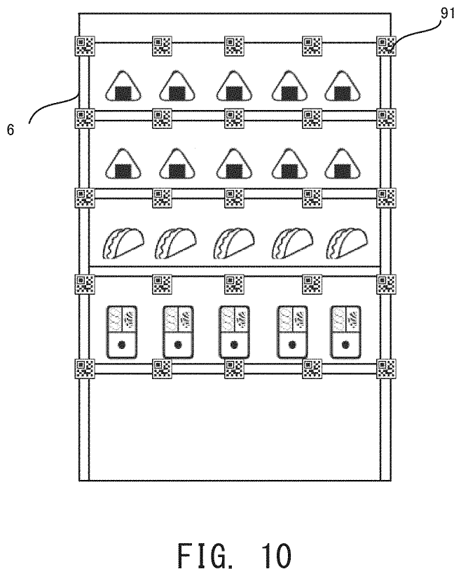

Next, the second image generation method will be described. The second image generation method is an image generation method whose processing details are automatically set based on the captured image 71 (i.e., without requiring the user's setting operation for setting the processing details of the second image generation method). In this case, as illustrated in FIG. 10, a plurality of marks (in other words, indexes) 91, which are referred to by the image generation unit 112 to set the processing details of the second image generation method, are disposed in advance on the display shelf 6. The marks 91 are disposed on the display shelf 6 so as to be arranged in a predetermined arrangement pattern when the display shelf 6 is viewed from the front. In the example illustrated in FIG. 10, the marks 91 are disposed on the display shelf 6 so as to be arranged in a matrix-like (i.e., grid-like) arrangement pattern of 5 rows×5 columns when the display shelf 6 is viewed from the front.

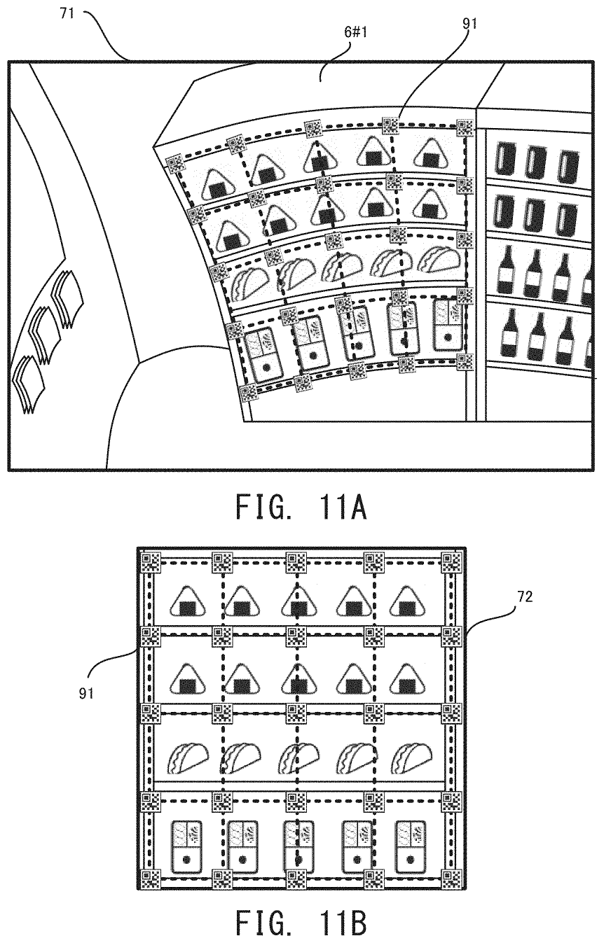

FIG. 11A illustrates the captured image 71 of the display shelf 6 on which such marks 91 are disposed. As illustrated in FIG. 11A, the captured image 71 also shows the marks 91 disposed on the display shelf 6, in addition to the display shelf 6. In the captured image 71, due to the distortion of the captured image 71 (i.e., the distortion of the display shelf 6 in the captured image 71), there is a possibility that the marks 91 are not arranged in the predetermined arrangement pattern. In this case, the image generation unit 112 calculates the disposed positions of the marks 91 in the captured image 71, and sets the processing details of the second image generation method based on the calculated disposed positions of the marks 91 and the original arrangement pattern of the marks 91 (the matrix-like arrangement pattern in the example illustrated in FIG. 10). For example, the image generation unit 112, as illustrated in FIG. 11B, may generate details of a process for deforming the captured image 71 such that the marks 91 that appear in the captured image 71 are arranged in the predetermined arrangement pattern, as the processing details of the second image generation method. For example, the image generation unit 112, as illustrated in FIG. 11B, may generate details of a process for generating the front shelf image 72 from the captured image 71 such that the marks 91 are arranged in the predetermined arrangement pattern in the front shelf image 72 generated from the captured image 71, as the processing details of the second image generation method. In this case, it can be said that the image generation unit 112 substantially generates the front shelf image 72 from the captured image 71 based on the marks 91.

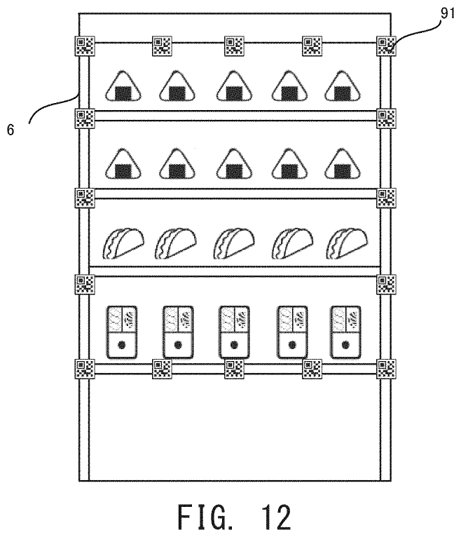

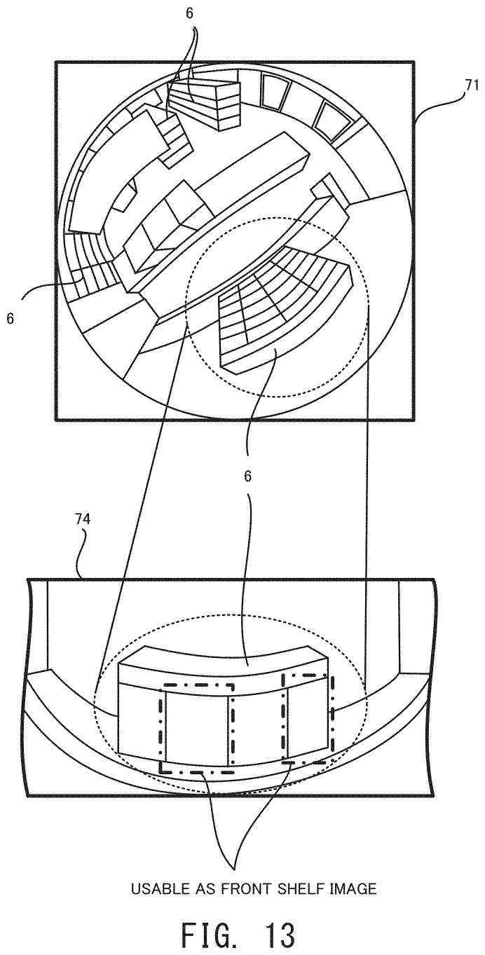

Incidentally, the disposed positions and the number of the plurality of marks 91 illustrated in FIG. 10 are merely an example. Therefore, the marks 91 may be disposed on the display shelf 6 such that any number of marks 91 are arranged in an arbitrary arrangement pattern. For example, as illustrated in FIG. 12, the marks 91 that connect the outer edge of the display shelf 6 (especially, the outer edge of a shelf part to be included in the front shelf image 72) may be disposed on the display shelf 6. Even in this case, the image generation unit 112 is capable of calculating the disposed positions of the marks 91 in the captured image 71, and to set the processing details of the second image generation method based on the calculated disposed positions of the marks 91 and the original arrangement pattern of the marks 91. However, if a distance between two adjacent marks 91 is relatively large, the image generation unit 112 may set the processing details of the second image generation method on the assumption that there is a virtual mark 91 on a straight line that connects between the two adjacent marks 91 or on a line that can be expressed by a predetermined mathematical expression (e.g., a line corresponding to the reference line 82 described above).

Furthermore, the second image generation method does not necessarily require the user's setting operation for setting the processing details of the image generation method. In this case, the store monitoring server 1 that generates the front shelf image 72 by using the second image generation method may not include the input apparatus 14 that receives an input of the user's setting operation (see FIG. 14 described later). The store monitoring server 1 that generates the front shelf image 72 by using the second image generation method may not include the display apparatus 15 that displays an image that can be referred to when the user inputs the setting operation (e.g., at least one of the captured image 71, the front shelf image 72, and the teacher image 73, as illustrated in FIG. 9) (see FIG. 14 described later).

Next, the third image generation method will be described. The third image generation operation is an image generation method whose processing details are automatically set based on the captured image 71 and the teacher image 73 (see FIG. 9) (i.e., without requiring the user to set the processing details of image generation method. In this case, the image generation unit 112 extracts a feature point of the display shelf 6 that appears in the captured image 71, based on the captured image 71. Furthermore, the image generation unit 112 extracts a feature point of the display shelf 6 that appears in the teacher image 73, based on the teacher image 73. Then, the image generation unit 112 may generate details of a process for deforming the captured image 71 such that the feature point of the display shelf 6 in the captured image 71 approaches or matches the feature point of the display shelf 6 in the teacher image 73, as the processing details of the second image generation method. In this case, it can be said that the image generation unit 112 substantially generates the front shelf image 72 from the captured image 71 based on the teacher image 73.

Alternatively, the image generation unit 112 may specify the shape and size of the display shelf 6 in the captured image 71 based on the feature point of the display shelf 6 that appears in the captured image 71. Furthermore, the image generation unit 112 may specify the shape and size of the display shelf 6 in the teacher image 73 based on the feature point of the display shelf 6 that appears in the teacher image 73. For example, the image generation unit 112 may specify a height of the display shelf 6, a width of the display shelf 6, and a distance between two adjacent shelf plates, as the shape and size of the display shelf 6. Then, the image generation unit 112 may generate details of a process for deforming the captured image 71 such that the shape and size of the display shelf 6 in the captured image 71 approaches or matches the shape and size of the display shelf 6 in the teacher image 73, as the processing details of the second image generation method. That is, the image generation unit 112 may generate details of a process for generating the front shelf image 72 from the captured image 71 such that the shape and size of the display shelf 6 in the front shelf image 72 generated from the captured image 71 approaches or matches the shape and size of the display shelf 6 in the teacher image 73, as the processing details of the second image generation method.

The third image generation method, as in the second image generation method, does not necessarily require the user's setting operation for setting the processing details of the image generation method. Therefore, the store monitoring server 1 that generates the front shelf image 72 by using the third image generation method may not include at least one of the input apparatus 14 and the display apparatus 15 (see FIG. 14 described later).

As described above, the store monitoring system 4 according to the example embodiment is configured to appropriately monitor the display shelf 6 in the store 5. In particular, the store monitoring system 4 may generate the front shelf image 72 that does not show the object that is not required to monitor the display shelf 6, from the captured image 71 that shows the object that is not required to monitor the display shelf 6. Therefore, the store monitoring system 4 is capable of appropriately monitoring the display shelf 6 to be monitored, without being adversely affected by the object that is not required to monitor the display shelf 6.

Furthermore, the store monitoring system 4 is configured to appropriately set the processing details of the first image generation method based on the user's setting operation. Therefore, the store monitoring system 4 is capable of generating the front shelf image 71 while considering the user's knowledge.

In addition, the store monitoring system 4 is configured to automatically set the processing details of the second or third image generation method without requiring the user's setting operation. Therefore, the store monitoring system 4 is capable of reducing the user's burden required to set the processing details of the image generation method. At this time, since the processing details of the image generation method are automatically set when the marks 91 are disposed on the display shelf 6, it is sufficient that the user disposes the marks 91 on the display shelf 6. Alternatively, if the marks 91 are disposed on the display shelf 6 from the beginning, the user may not even dispose the marks 91 on the display shelf 6. Furthermore, when the teacher image 73 is available, the user may not even dispose the marks 91 on the display shelf 6. Therefore, the store monitoring system 4 is capable of further reducing the user's burden required to set the processing details of the image generation method.

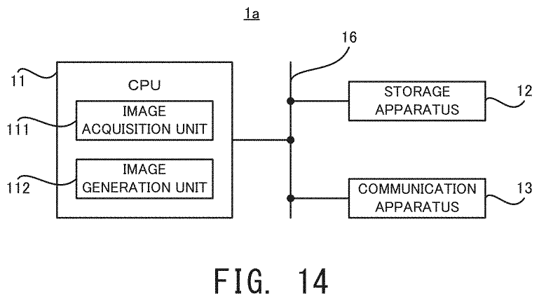

Incidentally, as described above, when the camera 21 is a fisheye camera including a circumferential fisheye lens, the captured image 71 captured by the camera 21 is an image in which a scene included in an imaging range of full 360 degrees is projected in a circular area, as illustrated in an upper part of FIG. 13. In this case, the image generation unit 112 may develop (i.e., develop in plane) the captured image 71 illustrated in the upper part of FIG. 13 to a panoramic image 74 illustrated in a lower part of FIG. 13, in order to generate the front shelf image 72 from the captured image 71. Here, as illustrated in the lower part of FIG. 13, there is a possibility that the panoramic image 74 generated by developing in plane the captured image 71 shows the display shelf 6 in a relatively little distortion. In this instance, the image generation unit 112 may extract an image portion that shows the display shelf 6 with a relatively little distortion, from the panoramic image 74. The extracted image portion (i.e., the image portion that shows the display shelf 6 with a relatively little distortion) may be used as the front shelf image 72.

In the above description, the store monitoring system 4 includes the store monitoring server 1 including the monitoring unit 113. The store monitoring system 4, however, may include a store monitoring server 1a that does not include the monitoring unit 113 and that is illustrated in FIG. 14, in place of the store monitoring server 1. In this case, an external apparatus of the store monitoring server 1a may include the monitoring unit 113. The monitoring unit 113 provided by the external apparatus of the store monitoring server 1a may perform the monitoring operation by using the front shelf image 72 generated by the store monitoring server 1a.

In the above description, the store monitoring system 4 includes the store monitoring server 1 including the storage apparatus 12 that stores therein the image DB 121. The store monitoring system SYS, however, may include the storage apparatus 12 that does not store therein the image DB 121 and that is illustrated in FIG. 14, in place of the store monitoring server 1. In this case, the image DB 121 may be stored in an external apparatus of the store monitoring server 1a.

The present invention is not limited to the examples described above and is allowed to be changed, if desired, without departing from the essence or spirit of the invention which can be read from the claims and the entire specification. A store monitoring system, a store monitoring apparatus, a store monitoring method, a computer program and a recording medium with such changes are also intended to be within the technical scope of the present invention.

To the extent permitted by law, this application is based upon and claims the benefit of priority from Japanese Patent Application No. 2019-198268, filed Oct. 31, 2019, and incorporates all of its disclosure herein. Also, to the extent permitted by law, all the publications and articles described herein are incorporated herein by reference.

### DESCRIPTION OF REFERENCE CODES

1 Store monitoring server
11 CPU
111 Image acquisition unit
112 Image generation unit
113 Monitoring unit
12 Storage apparatus
121 Image DB
13 Communication apparatus
14 Input apparatus
15 Display apparatus
2 Imaging apparatus
21 Camera
22 Communication apparatus
4 Store monitoring system
71 Captured image
72 Front shelf image
81 Reference point
82 Reference line

What is claimed is:

1. A store monitoring system comprising:
an imaging apparatus; and
a store monitoring apparatus that monitors a display shelf in a store by using a captured image captured by the imaging apparatus,
the store monitoring apparatus including:
at least one memory configured to store instructions; and
at least one processor configured to execute the instructions to:
sequentially obtain the captured image from the imaging apparatus; and
extract from the captured image a shelf image in which the display shelf appears, by eliminating from the captured image a non-shelf image in which the display shelf does not appear, and generate a front shelf image obtained when the display shelf is imaged from a front, by correcting a distortion of the shelf image.

2. The store monitoring system according to claim 1, wherein
the store monitoring apparatus further includes a storage that sequentially stores the front shelf image.

3. The store monitoring system according to claim 2, wherein
the storage changes the number of front shelf images stored per unit time by the storage, based on an amount of change per unit time in a condition of the display shelf indicated by the front shelf image.

4. The store monitoring system according to claim 2, wherein
the storage increases the number of front shelf images stored per unit time by the storage, with an increase in the amount of change per unit time in the condition of the display shelf indicated by the front shelf image.

5. The store monitoring system according to claim 1, wherein
the at least one processor configured to execute the instructions to generate the front shelf image based on an operation performed by a user.

6. The store monitoring system according to claim 1, wherein
the imaging apparatus images the display shelf with an index attached to the display shelf, and
the at least one processor configured to execute the instructions to generate the front shelf image based on the index that appears in the captured image.

7. The store monitoring system according to claim 1, wherein
the at least one processor configured to execute the instructions to generate the front shelf image based on an actual image obtained by actually imaging the display shelf from the front.

8. A store monitoring apparatus that monitors a display shelf in a store,
the store monitoring apparatus comprising:
at least one memory configured to store instructions; and
at least one processor configured to execute the instructions to:
sequentially obtain a captured image captured by an imaging apparatus; and
extract from the captured image a shelf image in which the display shelf appears, by eliminating from the captured image a non-shelf image in which the display shelf does not appear, and generate a front shelf image obtained when the display shelf is imaged from a front, by correcting a distortion of the shelf image.

9. A store monitoring method that monitors a display shelf in a store,
the store monitoring method comprising:
sequentially obtaining a captured image captured by an imaging apparatus; and
extracting from the captured image a shelf image in which the display shelf appears, by eliminating from the captured image a non-shelf image in which the display shelf does not appear, and generating a front shelf image obtained when the display shelf is imaged from a front, by correcting a distortion of the shelf image.

10. (canceled)
